(19) United States
(12) Patent Application Publication
(10) Pub. No.: US 2025/0324950 A1
(43) Pub. Date: Oct. 23, 2025

(54) SELF-CLEANING CULTIVATION DEVICE AND CULTIVATION METHOD FOR BURROWING SHELLFISH

(71) Applicants: Jiangsu Ocean University, Lianyungang (CN); Lanwan Technology Innovation Center for Marine Resource Development, Lianyungang (CN)

(72) Inventors: Zhiguo DONG, Lianyungang (CN); Shiyu YAN, Lianyungang (CN); Guojun HE, Lianyungang (CN); Chaohua WANG, Lianyungang (CN); Huan YANG, Lianyungang (CN); Zhengyi LI, Lianyungang (CN)

(73) Assignees: Jiangsu Ocean University, Lianyungang (CN); Lanwan Technology Innovation Center for Marine Resource Development, Lianyungang (CN)

(21) Appl. No.: 19/084,822

(22) Filed: Mar. 20, 2025

(30) Foreign Application Priority Data
Apr. 23, 2024 (CN) 202410491833.6

(51) Int. Cl. A01K 61/54

(52) U.S. Cl. CPC A01K 61/54

(57) ABSTRACT

A self-cleaning cultivation device and a cultivation method for burrowing shellfish are provided. The self-cleaning cultivation device includes a cultivation box. A bottom end inside the cultivation box is provided with a cultivation substrate. The cultivation substrate is composed of a bottom plate, a second drain pipe, and exhaust pipes. A serpentine gas delivery pipe is installed inside the bottom plate. One end of the serpentine gas delivery pipe is provided with an inflation connection port, and the inflation connection port is connected to an air pump through an inflation pipeline. The cultivation substrate of the present invention adopts a glass bead substrate. During the industrialized cultivation, the cultivation substrate does not react with the excreta of shellfish and the fed algae. The cultivation device of the present invention can efficiently remove harmful impurities, ensure a healthy cultivation environment, and reduce the occurrence of diseases.

### CROSS REFERENCE TO THE RELATED APPLICATIONS

This application is based upon and claims priority to Chinese Patent Application No. 202410491833.6, filed on Apr. 23, 2024, the entire contents of which are incorporated herein by reference.

### TECHNICAL FIELD

The present invention relates to the technical field of burrowing shellfish cultivation, in particular to a self-cleaning cultivation device and a cultivation method for burrowing shellfish.

### BACKGROUND

At present, in industrialized cultivation, sediment is used as a cultivation substrate for both the seedling growing and cultivation of burrowing shellfish. In the cultivation of burrowing shellfish, the cultivation habitat is of great importance. Burrowing shellfish generally lead a filter-feeding life, and rely on siphons at the posterior end of their bodies for respiration, feeding and excretion. The type of the substrate is very closely related to the cultivation of burrowing shellfish. The substrate plays roles such as an activity base, an attachment point, a shelter, and a source of nutrients in shellfish cultivation. In the filter-feeding life of burrowing shellfish, their excrement is discharged onto the surface layer of the substrate through an exhalant siphon, after decomposition for a period of time, water and the substrate will be polluted, moreover, leftover baits from feeding will also pollute the substrate, the long-term reaction with the substrate will generate sulfides, ammonia nitrogen, nitrites and other indicators in the water will rise, leading to deaths of a large number of shellfish, and the sediment substrate is not easy to clean and disinfect during industrialized cultivation. In the prior art, the research on substrates mainly focuses on the proportion of sand to silt. There has been no report on the research and development of new material substrates by completely replacing the sediment substrate in terms of substrate composition. Therefore, a self-cleaning cultivation device and a cultivation method for burrowing shellfish are provided.

### SUMMARY

Aiming at the deficiencies of the prior art, the objective of the present invention is to provide a self-cleaning cultivation device and a cultivation method for burrowing shellfish, so as to solve the problems provided in the above background.

In order to achieve the above objective, the present invention provides the following technical solution. A self-cleaning cultivation device for burrowing shellfish, including a cultivation box, where a bottom end inside the cultivation box is provided with a cultivation substrate, the cultivation substrate is composed of a bottom plate, a second drain pipe, and exhaust pipes, a serpentine gas delivery pipe is installed inside the bottom plate, one end of the serpentine gas delivery pipe is provided with an inflation connection port, the inflation connection port is connected to an air pump through an inflation pipeline, a top of the serpentine gas delivery pipe is connected to several exhaust pipes, the second drain pipe is installed at a middle end inside the bottom plate, one end of the second drain pipe is provided with an inner connection drain port, a blowdown pipe is connected onto the inner connection drain port, a solenoid valve is installed on the blowdown pipe, the other end of the second drain pipe is provided with a first drain pipe connection port, a first drain pipe is connected onto the first drain pipe connection port, a top of the first drain pipe is connected to a funnel, and a top of the cultivation substrate is provided with several glass beads.

As a preferred technical solution of the present invention, a top of each of the exhaust pipes is provided with a screen, and the aperture of the screen is 0.2 to 0.5 mm.

As a preferred technical solution of the present invention, the funnel is connected to the top of the first drain pipe by threads, and a bottom of the first drain pipe is connected to the first drain pipe connection port at an end of the second drain pipe by threads.

As a preferred technical solution of the present invention, the first drain pipe is a telescopic pipeline.

As a preferred technical solution of the present invention, the exhaust pipes are connected to the serpentine gas delivery pipe by threads.

As a preferred technical solution of the present invention, the particle size of the glass beads is 0.6 to 1 mm.

As a preferred technical solution of the present invention, one side of the cultivation substrate is provided with a water inlet, the water inlet is connected to a tap water pipe, and a solenoid valve is installed on the tap water pipe at the water inlet.

A method for shellfish cultivation using the self-cleaning cultivation device for burrowing shellfish includes the specific steps as follows:
S1: placing bivalve burrowing shellfish in the cultivation box, and generating feces and leftover baits on the glass beads at the top of the cultivation substrate after 3 days of cultivation;
S2: setting, by a programmable logic controller (PLC) control panel, the air pump to be started once every three days, with each operation lasting 10 to 15 min, inputting air into the serpentine gas delivery pipe when the air pump works, exhausting gas through the exhaust pipes at the top of the serpentine gas delivery pipe, blowing the feces and the leftover baits attached to glass beads at a bottom into water, and blocking, by screens at the tops of the exhaust pipes, glass balls from entering the exhaust pipes in exhausting gas;
S3: automatically opening, by the PLC control panel, the solenoid valve on the blowdown pipe, and collecting and discharging the water containing the feces and the leftover baits through the funnel with a pre-set height; and
S4: after sewage in the cultivation box is discharged, opening the solenoid valve on the tap water pipe and replenishing water with tap water, when a set water level is reached, controlling, by a liquid level sensor, the solenoid valve on the tap water pipe to be closed, thus completing a water changing and cleaning work.

Compared with the prior art, the present invention has the beneficial effects. The cultivation substrate of the present invention adopts a glass bead substrate. During the industrialized cultivation, the cultivation substrate does not react with the excreta of shellfish and the fed algae. The cultivation device of the present invention can efficiently remove harmful impurities, ensure a healthy cultivation environment, reduce the occurrence of diseases, and reduce the problem that soil and sand are difficult to clean in industrialized cultivation, thus reducing labor costs. Meanwhile, the glass bead substrate can be recycled, and can also promote high-density cultivation and improve cultivation economy.

### BRIEF DESCRIPTION OF THE DRAWINGS

FIG. 1 is a schematic structural diagram of a cultivation box according to the present invention;

FIG. 2 is a schematic diagram of a connection structure of a funnel and a first drain pipe according to the present invention; and

FIG. 3 is a schematic structural diagram of a cultivation substrate according to the present invention.

Reference numerals: 1. Cultivation box; 2. Funnel; 3. Cultivation substrate; 4. Inflation connection port; 5. Inner connection drain port; 6. First drain pipe; 7. Exhaust pipe; 8. First drain pipe connection port; 9. Second drain pipe; 10. Bottom plate.

### DETAILED DESCRIPTION OF THE EMBODIMENTS

The preferred embodiments of the present invention will be described in detail with reference to the accompanying drawings, so that the advantages and features of the present invention can be more readily understood by those skilled in the art, and thus the scope of protection of the present invention can be more clearly defined.

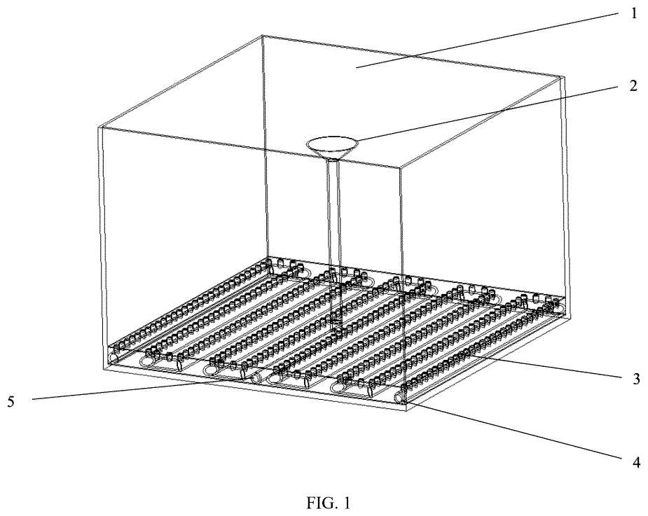

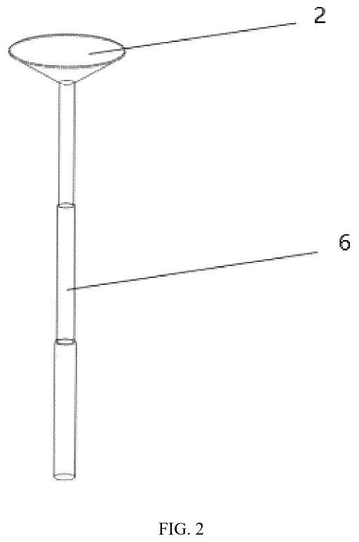

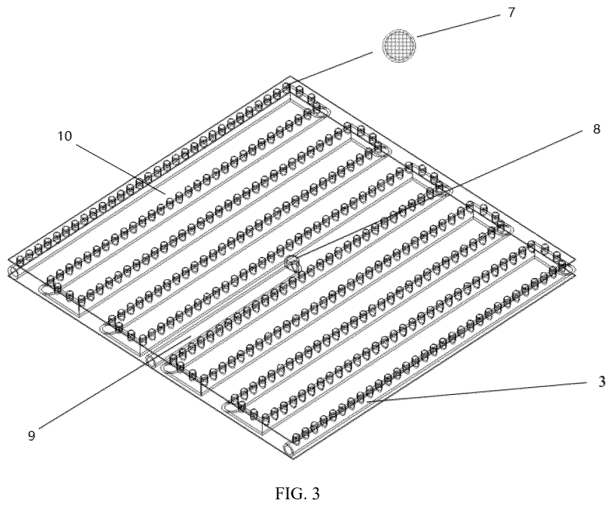

Referring to FIGS. 1-3, the present invention provides a technical solution. A self-cleaning cultivation device for burrowing shellfish, including a cultivation box 1, where a bottom end inside the cultivation box 1 is provided with a cultivation substrate 3, the cultivation substrate 3 is composed of a bottom plate 10, a second drain pipe 9, and exhaust pipes 7, a serpentine gas delivery pipe is installed inside the bottom plate 10, one end of the serpentine gas delivery pipe is provided with an inflation connection port 4, the inflation connection port 4 is connected to an air pump through an inflation pipeline, a top of the serpentine gas delivery pipe is connected to several exhaust pipes 7, the second drain pipe 9 is installed at a middle end inside the bottom plate 10, one end of the second drain pipe 9 is provided with an inner connection drain port 5, a blowdown pipe is connected onto the inner connection drain port 5, a solenoid valve is installed on the blowdown pipe, the other end of the second drain pipe 9 is provided with a first drain pipe connection port 8, a first drain pipe 6 is connected onto the first drain pipe connection port 8, a top of the first drain pipe 6 is connected to a funnel 2, and a top of the cultivation substrate 3 is provided with several glass beads.

A top of each of the exhaust pipes 7 is provided with a screen, and the aperture of the screes is 0.2 to 0.5 mm.

The funnel 2 is connected to the top of the first drain pipe 6 by threads, and a bottom of the first drain pipe 6 is connected to the first drain pipe connection port 8 at an end of the second drain pipe 9 by threads.

The first drain pipe 6 is a telescopic pipeline.

The exhaust pipes 7 are connected to the serpentine gas delivery pipe by threads.

The particle size of the glass beads is 0.6 to 1 mm.

One side of the cultivation substrate 3 is provided with a water inlet, the water inlet is connected to a tap water pipe, and a solenoid valve is installed on the tap water pipe at the water inlet.

A method for shellfish cultivation using the self-cleaning cultivation device for burrowing shellfish includes the specific steps as follows:
S1: placing bivalve burrowing shellfish in the cultivation box, and generating feces and leftover baits on the glass beads at the top of the cultivation substrate 3 after 3 days of cultivation;
S2: setting, by a PLC control panel, the air pump to be started once every three days, with each operation lasting 10 to 15 min, inputting air into the serpentine gas delivery pipe when the air pump works, exhausting gas through the exhaust pipes 7 at the top of the serpentine gas delivery pipe, blowing the feces and the leftover baits attached to glass beads at a bottom into water, and blocking, by the screens at the tops of the exhaust pipes 7, glass balls from entering the exhaust pipes 7 in exhausting gas;
S3: automatically opening, by the PLC control panel, the solenoid valve on the blowdown pipe, and collecting and discharging the water containing the feces and the leftover baits through the funnel 2 with a pre-set height; and
S4: after sewage in the cultivation box 1 is discharged, opening the solenoid valve on the tap water pipe and replenishing water with tap water, when a set water level is reached, controlling, by a liquid level sensor, the solenoid valve on the tap water pipe to be closed, thus completing a water changing and cleaning work.

### Example 1

Cultivation substrate for Cyclina sinensis: According to the submergence depth of Cyclina sinensis, a substrate of glass beads (with a particle size of 1 mm) with a thickness of 5 cm was laid in the self-cleaning cultivation box with dimensions of 2 m×2 m×1.5 m of the present invention.

### Comparative Example 1

Cultivation substrate for Cyclina sinensis: According to the submergence depth of Cyclina sinensis cultivation, a substrate of sediment (120 meshes) with a sand-to-silt ratio of 6:4 was laid in a common commercial cultivation box with dimensions of 2 m×2 m×1.5 m; the sediment was from the beach of Haizhou Bay; and the thickness of the laid substrate was 5 cm.

### Comparative Example 2

Cultivation substrate for Cyclina sinensis: According to the submergence depth of Cyclina sinensis, a substrate of glass beads (with a particle size of 1 mm) with a thickness of 5 cm was laid in a common commercial cultivation box with dimensions of 2 m×2 m×1.5 m of the present invention.

Experiments were conducted using the Cyclina sinensis substrates of Example 1, Comparative Example 1, and Comparative Example 2.

After laying the substrate, 25 Cyclina sinensis were placed in each cultivation box. The size was indicated by a shell length, which was 16.14±1.64 mm. For flow-through cultivation, the fresh weight of Cyclina sinensis was measured before cultivation, after 3 months of cultivation, and after 6 months of cultivation, respectively. The fresh weight growth rate was calculated at the end of the cultivation. The results are shown in Table 1 below:

TABLE 1
Weight gain rates of Example 1, Comparative Example 1, and
Comparative Example 2 during different cultivation periods

| | Before | After 3 months | After 6 months | Weight |
|---|---|---|---|---|
| | cultivation | of cultivation | of cultivation | gain rate |
| Example 1 | 2.71 g | 4.29 g | 6.73 g | 57.6% |
| Comparative | 2.63 g | 3.47 g | 5.24 g | 41.5% |
| Example 1 | | | | |
| Comparative | 2.68 g | 3.24 g | 4.83 g | 35.0% |
| Example 2 | | | | |

### Example 2

Cultivation substrate for Cyclina sinensis: According to the submergence depth of Cyclina sinensis, a substrate of glass beads (with a particle size of 1 mm) with a thickness of 5 cm was laid in the self-cleaning cultivation box with dimensions of 2 m×2 m×1.5 m of the present invention.

### Comparative Example 3

Cultivation substrate for Cyclina sinensis: According to the submergence depth of Cyclina sinensis cultivation, a substrate of sediment (5 meshes) with a sand-to-silt ratio of 6:4 was laid in a common commercial cultivation box with dimensions of 2 m×2 m×1.5 m; the sediment was from the beach of Haizhou Bay; and the thickness of the laid substrate was 5 cm.

Experiments were conducted using the Cyclina sinensis substrates of Example 2, Comparative Example 2, and Comparative Example 3.

After laying the substrate, 25 Cyclina sinensis were placed in each cultivation box. The size was indicated by a shell length, which was 16.14±1.64 mm. For flow-through cultivation, the water flowing was stopped after 14 days of cultivation. The water was left still for two days, and no feeding was carried out during these two days. The bottom-layer water quality was sampled to measure total phosphorus, total nitrogen, nitrite, and ammonia nitrogen. The results are shown in Table 2 below:

TABLE 2
Total phosphorus, total nitrogen, nitrite, and ammonia nitrogen in the bottom-layer
water quality of Example 2, Comparative Example 2, and Comparative Example 3

| | Total | | | Ammonia |
|---|---|---|---|---|
| | phosphorus | Total nitrogen | Nitrite | nitrogen |
| | mg · L⁻¹ | mg · L⁻¹ | mg · L⁻¹ | mg · L⁻¹ |
| Example 2 | 0.068 ± 0.001 | 0.013 ± 0.007 | 0.019 ± 0.005 | 0.027 ± 0.000 |
| Comparative | 0.313 ± 0.010 | 0.297 ± 0.014 | 0.411 ± 0.009 | 0.407 ± 0.003 |
| Example 2 | | | | |
| Comparative | 0.126 ± 0.004 | 0.219 ± 0.006 | 0.225 ± 0.017 | 0.247 ± 0.008 |
| Example 3 | | | | |

### Example 4

Cultivation substrate for Cyclina sinensis: According to the submergence depth of Cyclina sinensis, a substrate of glass beads (with a particle size of 1 mm) with a thickness of 5 cm was laid in a common commercial cultivation box with dimensions of 2 m×2 m×1.5 m of the present invention.

### Comparative Example 4

Cultivation substrate for Cyclina sinensis: According to the submergence depth of Cyclina sinensis, a substrate of glass beads (with a particle size of 0.1 mm and below) with a thickness of 5 cm was laid in a common commercial cultivation box with dimensions of 2 m×2 m×1.5 m of the present invention.

### Comparative Example 5

Cultivation substrate for Cyclina sinensis: According to the submergence depth of Cyclina sinensis, a substrate of glass beads (with a particle size of more than 2 mm) with a thickness of 5 cm was laid in a common commercial cultivation box with dimensions of 2 m×2 m×1.5 m of the present invention.

Experiments were conducted using the Cyclina sinensis substrates of Example 2, Example 4, Comparative Example 4, and Comparative Example 5.

TABLE 3
Submergence rates and survival rates at different
times for Example 2, Example 4, Comparative
Example 4, and Comparative Example 5

| | Submergence | Submergence | Survival |
|---|---|---|---|
| | rate (1 h) | rate (24 h) | rate |
| Example 4 | 70% | 100% | 34% |
| Comparative | 76% | 100% | 16% |
| Example 4 | | | |
| Comparative | 24% | 32% | 20% |
| Example 5 | | | |
| Example 2 | 72% | 100% | 100% |

The above-mentioned examples merely represent the implementation modes of the present invention. Their descriptions are relatively specific and detailed, but this should not be construed as a limitation on the scope of the invention patent. It should be pointed out that, for those of ordinary skill in the art, without departing from the concept of the present invention, several modifications and improvements can still be made, and these all fall within the scope of protection of the present invention.

What is claimed is:

1. A self-cleaning cultivation method for a burrowing shellfish, implemented by using a self-cleaning cultivation device for the burrowing shellfish, wherein the self-cleaning cultivation device comprises a cultivation box, wherein a bottom end inside the cultivation box is provided with a cultivation substrate, the cultivation substrate comprises a bottom plate, a second drain pipe, and a plurality of exhaust pipes, a serpentine gas delivery pipe is installed inside the bottom plate, an end of the serpentine gas delivery pipe is provided with an inflation connection port, the inflation connection port is connected to an air pump through an inflation pipeline, a top of the serpentine gas delivery pipe is connected to the plurality of exhaust pipes, the second drain pipe is installed at a middle end inside the bottom plate, a first end of the second drain pipe is provided with an inner connection drain port, a blowdown pipe is connected onto the inner connection drain port, a first solenoid valve is installed on the blowdown pipe, a second end of the second drain pipe is provided with a first drain pipe connection port, a first drain pipe is connected onto the first drain pipe connection port, a top of the first drain pipe is connected to a funnel, and a top of the cultivation substrate is provided with a plurality of glass beads;
a top of each of the plurality of exhaust pipes is provided with a screen, and an aperture of the screen is 0.2 to 0.5 mm;
a side of the cultivation substrate is provided with a water inlet, the water inlet is connected to a tap water pipe, and a second solenoid valve is installed on the tap water pipe at the water inlet; and
the self-cleaning cultivation method comprises steps as follows:
S1: placing a bivalve burrowing shellfish in the cultivation box, and generating feces and leftover baits on the plurality of glass beads at the top of the cultivation substrate after 3 days of a cultivation;
S2: setting, by a programmable logic controller (PLC) control panel, the air pump to be started once every three days, with each operation lasting 10 to 15 min, inputting air into the serpentine gas delivery pipe when the air pump works, exhausting gas through the plurality of exhaust pipes at the top of the serpentine gas delivery pipe, blowing the feces and the leftover baits attached to the plurality of glass beads at a bottom into water, and blocking, by the screen at the top of each of the plurality of exhaust pipes, glass balls from entering the plurality of exhaust pipes in exhausting the gas;
S3: automatically opening, by the PLC control panel, the first solenoid valve on the blowdown pipe, and collecting and discharging the water containing the feces and the leftover baits through the funnel with a pre-set height; and
S4: after a sewage in the cultivation box is discharged, opening the second solenoid valve on the tap water pipe and replenishing the water with tap water, when a set water level is reached, controlling, by a liquid level sensor, the second solenoid valve on the tap water pipe to be closed, thus completing a water changing and cleaning work.

2. The self-cleaning cultivation method according to claim 1, wherein the funnel is connected to the top of the first drain pipe by first threads, and a bottom of the first drain pipe is connected to the first drain pipe connection port at the second end of the second drain pipe by second threads.

3. The self-cleaning cultivation method according to claim 1, wherein the first drain pipe is a telescopic pipeline.

4. The self-cleaning cultivation method according to claim 1, wherein the plurality of exhaust pipes are connected to the serpentine gas delivery pipe by threads.

5. The self-cleaning cultivation method according to claim 1, wherein a particle size of each of the plurality of glass beads is 0.6 to 1 mm.
